(19) United States
(12) Patent Application Publication
(10) Pub. No.: US 2014/0279410 A1
(43) Pub. Date: Sep. 18, 2014

(54) SYSTEM AND METHOD FOR TRANSFERING FINANCIAL ACCOUNTS

(71) Applicants: Andrew Milligan, Basiglio (IT); Fabrizio Gardiol, San Pietro Val Lemina (IT)

(72) Inventors: Andrew Milligan, Basiglio (IT); Fabrizio Gardiol, San Pietro Val Lemina (IT)

(21) Appl. No.: 13/804,165

(22) Filed: Mar. 14, 2013

(51) Int. Cl. G06Q 40/02

(52) U.S. Cl. CPC G06Q 40/02
USPC 705/39

(57) ABSTRACT

A system and method for transferring a financial account between a first financial institution and a second financial institution. A transfer application, executing on a transfer server, provides a graphical user interface that enables users to view options and select a second financial institution.

### FIELD OF THE INVENTION

The present invention relates to managing accounts at financial institutions and, more particularly, to transferring an account between financial institutions.

### BACKGROUND OF THE INVENTION

Financial institutions often have a captive client base as the cost of transferring an account from a first financial institution to a second financial institution is high in terms of time. Should a client discover that another financial institution is offering better terms than the client's financial institution, there may be a significant number of forms, etc. to complete a transfer using a conventional paper based transfer of accounts. As used herein, better terms may generally comprise, for example, a higher interest rate on current accounts, a lower interest on a mortgage account, lower commission fees for trades in a securities account, etc. However, it should be noted that the list of better terms contained herein should be exemplary only and not viewed as exhaustive.

### SUMMARY OF THE INVENTION

The noted disadvantages of the prior art are overcome by providing a system and method for transferring accounts. An illustrative transfer application executes on a transfer server and provides web based access for users. In alternative embodiments, users may access the transfer application via a dedicated application executing on a mobile device that communicates with the transfer server. Users register with the transfer server to create an account thereon. Financial institutions, e.g., banks, mortgage companies, stock brokers, etc., also register with the transfer server.

In operation, a user logs into the transfer application and is presented a main menu that provides options to, inter alia, transfer a current account, a securities account, a mortgage account, etc. In response to selecting one of the options, the transfer application displays a graphical user interface (GUI) window that presents options of alternative financial institutions. A user may scroll through the various options to view financial institutions' offerings. If the user decides on one, the user selects an icon associated with the financial institution and activates a transfer function.

The transfer application communicates with the old and new financial institutions to effectuate the transfer of the user's account. If a mortgage account is being transferred, a virtual notary is utilized to authenticate the user's signature. In alternative embodiments, the user may utilize a digital signature that is authenticated by the virtual notary. Once the transfer has been effectuated, the transfer application displays a confirmation window in the GUI.

### BRIEF DESCRIPTION OF THE DRAWINGS

The above and further advantages of the present invention are explained in relation to the following figures in which like reference numerals indicate similar functional or structural components, in which;

FIG. 1 is a schematic block diagram of an exemplary network environment in accordance with an illustrative embodiment of the present invention;

FIG. 2 is an exemplary schematic block diagram of an exemplary transfer server in accordance with an illustrative embodiment of the present invention;

FIG. 3 is an exemplary schematic block diagram of an exemplary mobile device in accordance with an illustrative embodiment of the present invention;

FIG. 4 is a flowchart detailing the steps of a procedure for transferring a current account in accordance with an illustrative embodiment of the present invention;

FIG. 5 is an exemplary graphical user interface window of an exemplary login screen in accordance with an illustrative embodiment of the present invention;

FIG. 6 is an exemplary graphical user interface window of an exemplary main menu in accordance with an illustrative embodiment of the present invention;

FIG. 7 is an exemplary graphical user interface window of an exemplary transfer application for transferring a current account in accordance with an illustrative embodiment of the present invention;

FIG. 8 is an exemplary graphical user interface window of an exemplary transfer application for transferring a current account in accordance with an illustrative embodiment of the present invention;

FIG. 9 is an exemplary graphical user interface window of an exemplary transfer application for transferring a current account in accordance with an illustrative embodiment of the present invention;

FIG. 10 is an exemplary graphical user interface window of an exemplary transfer application for transferring the current account in accordance with an illustrative embodiment of the present invention;

FIG. 11 is a flowchart detailing the steps of a procedure for transferring a securities account in accordance with an illustrative embodiment of the present invention;

FIG. 12 is an exemplary graphical user interface window of an exemplary transfer application for transferring a securities account in accordance with an illustrative embodiment of the present invention;

FIG. 13 is an exemplary graphical user interface window of an exemplary transfer application for transferring a securities account in accordance with an illustrative embodiment of the present invention;

FIG. 14 is an exemplary graphical user interface window of an exemplary transfer application for transferring a securities account in accordance with an illustrative embodiment of the present invention;

FIG. 15 is an exemplary graphical user interface window of an exemplary transfer application for transferring a securities account in accordance with an illustrative embodiment of the present invention;

FIG. 16 is an exemplary graphical user interface window of an exemplary transfer application for transferring a securities account in accordance with an illustrative embodiment of the present invention;

FIG. 17 is a flowchart detailing the steps of a procedure for transferring a mortgage account in accordance with an illustrative embodiment of the present invention;

FIG. 18 is an exemplary graphical user interface window of an exemplary transfer application for transferring a mortgage account in accordance with an illustrative embodiment of the present invention;

FIG. 19 is an exemplary graphical user interface window of an exemplary transfer application for transferring a mortgage account in accordance with an illustrative embodiment of the present invention;

FIG. 20 is an exemplary graphical user interface window of an exemplary transfer application for transferring a mortgage account in accordance with an illustrative embodiment of the present invention;

FIG. 21 is an exemplary graphical user interface window of an exemplary transfer application for transferring a mortgage account in accordance with an illustrative embodiment of the present invention;

FIG. 22 is an exemplary graphical user interface window of an exemplary transfer application for transferring a mortgage account in accordance with an illustrative embodiment of the present invention;

FIG. 23 is an exemplary graphical user interface window of an exemplary transfer application for transferring a mortgage account in accordance with an illustrative embodiment of the present invention; and

FIG. 24 is an exemplary graphical user interface window of an exemplary transfer application for transferring a mortgage account in accordance with an illustrative embodiment of the present invention.

### DETAILED DESCRIPTION OF AN ILLUSTRATIVE EMBODIMENT

FIG. 1 is a schematic block diagram of an exemplary network environment 100 in accordance with an illustrative embodiment of the present invention. The environment 100 is centered around a network 105 that may comprise any conventional form of networking including, for example, a TCP/IP network, and virtual private network (VPN), a local area network (LAN) or a wide area network (WAN), such as the well-known Internet. As will be appreciated by those skilled in the art, network 105 may comprise a plurality of different networks (not shown). It should be noted that the various networks may comprise different types and/or utilize differing protocols in accordance with alternative embodiments of the present nation. Portions of network 105 may comprise different types of networks, such as wireless networks, cellular networks, etc. in accordance with alternative embodiments of the present invention. As such, the description of network 105 comprising a single network should be taken as exemplary only.

Operatively interconnected with the network 105 are a plurality of financial institution server 110A,B,C. Financial institution servers 110 are illustratively associated with various financial institutions such as, e.g., banks, brokers, mortgage companies, etc. Each financial institution server 110 illustratively comprises an exemplary application program interface (API) 115 that is accessible to other systems connected to the network 105. The API 115 may comprise a set of functions that may be accessed via, e.g., remote procedure calls (RPCs).

Also operative connected with the network 105 is a transfer server 200, described below in relation to FIG. 2. The transfer server 200 illustratively implements functionality to enable the transfer of accounts from a first financial institution to a second financial institution in accordance with illustrative embodiments of the present invention. An exemplary mobile device 300 is also interconnected with the network 105. Illustratively, the mobile device is utilized by a user to access the transfer server's 200 functionality to effectuate a transfer of an account.

FIG. 2 is a schematic block diagram of an exemplary transfer server 200 in accordance with an illustrative embodiment of the present invention. The transfer server 200 illustratively comprises a processor 205, network adapter 210, storage controller 215 and memory 220 operatively interconnected by a network bus. The processor 205 typically comprises the necessary elements and/or logic adapted and configured to execute software programs and manipulate data structures in accordance with an illustrative embodiment of the present invention. While one processor 205 is shown and described in relation to FIG. 2, as will be appreciated by those skilled in the art, a plurality of processors 205 may be utilized to improve performance. Similarly, it should be noted that the description contained herein of the transfer server 200 comprising a single server should be taken as exemplary only. In accordance with alternative embodiments of the present invention, the functionality of the transfer server 200 may be distributed among a plurality of servers in a clustered configuration and/or may be distributed among a cloud-based server and/or storage environment.

The network adapter 210 illustratively contains the mechanical, electrical, and signaling circuitry for enabling communication of data over links coupled to the network 105. The network adapter 210 may be configured to transmit and/or receive data using a variety of different protocols including, inter alia, TCP/IP, UDP, ATM, asynchronous optical networks (SONET), wireless protocols, Frame Relay, Ethernet, fiber distributed data interface (FDDI), etc. Notably, the physical network adapter 210 may be used to implement one or more network interfaces, such as for a virtual private network (VPN) access, as will be known to those skilled in the art. It should be noted that in the illustrative embodiment described herein, a single network adapter 210 is shown and described operatively interconnecting the transfer server 200 to the network 105. However, it should be noted that in alternative embodiments, a plurality of network adapters 210 may be utilized to communicate with the network 105. Further, in alternative embodiments, a plurality of network adapters 210 may be utilized so that certain network adapters communicate with the network 105, other network adapters may directly communicate with parties' accounting systems 110, 120 and/or financial institution servers 130. As will be appreciated by those skilled in the art, a variety of network topologies may be utilized to implement the principles of the present invention. As such, the description of the network adapter 210 operatively interconnecting the transfer server 200 with network 105 should be taken as exemplary only.

The memory 220 stores a plurality of processes including, for example, a transfer application 230 and a web server 225. The transfer application 230 illustratively provides functionality to implement the various aspects of the present invention as described further below. Typically, financial institution servers 110 may expose a set of application programming interfaces (APIs) that may be accessed remotely via, for example, remote procedure call (RPCs). In such environments, the transfer application 230 may comprise a module that is configured to execute the necessary RPCs for a particular financial institution server 110 to implement the transfer.

The web server 225 is illustratively a conventional web server that enables users to access the transfer application 230 via the world wide web. In an illustrative embodiment of the present invention, the web server 225 provides a web site that enables users to access the functionality of the transfer application 230.

The storage controller 215 manages access to storage 235 associated with the transfer 200 in accordance with an illustrative embodiment of the present invention. The storage 235 may comprise a plurality of disk drives arranged in a fault tolerant array. However, it should be noted that in alternative embodiments, storage 235 may comprise any form of persistent media including, for example, flash RAM, tape, rewritable optical media, etc. Furthermore, the storage 235 may be distributed in a cloud based environment with redundancy and fault tolerance features. For example, the servers may be arranged in RAID arrays to enable recovery from the failure of one or more of the storage devices. In an alternative embodiment, the storage 235 may be replicated or mirrored at one or more locations to enable near immediate access to data stored thereon in the event of a failure of one of the plexes the minor.

FIG. 3 is a schematic block diagram of an exemplary mobile device 300 that may be utilized by a user in accordance with an illustrative embodiment of the present invention. The mobile device 300 illustratively comprises a processor 305, a network adapter 310, a display 315, and a memory 320. Illustrative, the processor executes software contained within the memory 320. The network adapter 310 provides an interface to network 105. Illustratively, the network adapter may function over a cellular network and/or wireless networks. As will be appreciated by those skilled in the art, a plurality of network adapters 310 may be required on the mobile device 300 to effectively operate over a plurality of different network types. As such, the description of a single network adapter 310 may be taken as exemplary only. The display 315 illustratively comprises a touch screen that is utilized both to display of information to a user as well as an input device. It should be noted that in alternative embodiments where the display does not comprise input functionality, the mobile device 300 may require an alternative input device, such as a keyboard (not show).

Within the memory 320, are illustrated a plurality of applications that may be executed by the processor 305. A web client 325 provides web browser functionality to enable a user to access a website provided by the web server 225. In alternative embodiments, a transfer app 330 provides access to the transfer application 230 executing on the transfer server 200. While the present invention has been described in terms of a user accessing the transfer application 230 using web client 325 and/or a transfer app 330, it should be noted that any technique may be utilized in communicating between a user and the transfer server. As such, the description of accessing the transfer server via the web and/or a transfer app should be taken as exemplary only.

FIG. 4 is a flowchart detailing the steps of an exemplary procedure 400 for transferring a current account in accordance with an illustrative embodiment of the present invention. The procedure 400 begins in step 405 and continues to step 410 where a user accesses the transfer application 230. Illustratively, the user accesses the transfer application 230 by, for example, utilizing a web browser 325 executing on a mobile device to access the website provided by the transfer server. In alternative embodiments, a user may access the transfer application by launching a dedicated application that is executed on a mobile device. It should be noted that while the present invention is described in terms of accessing the transfer server 200 via a mobile device 300, the principles of the present invention have utilized regardless of the device from which the transfer server is accessed. As such, the description of a mobile device 300 being utilized to access the transfer server 200 should be taken as exemplary only.

In step 415, the user logs into the transfer application 230. FIG. 5 is an exemplary graphical user interface (GUI) window 500 illustrating an exemplary log in screen window 500 in accordance with an illustrative embodiment of the present invention. Exemplary window 500 includes a user name field 505, password field 510 and an enter button 515. Illustratively, the user logs into the transfer application 230 by entering their username in the user field 505, their password in the password field 510 and executing the enter button 515. In accordance with an illustrative embodiment of the present invention, a user will have registered with the transfer application 230 at some prior point in time. Such registration may include, e.g., selecting a user name and password, registering the user's accounts with the transfer application, etc.

In response to the user logging into the application, the transfer application 230 displays a main menu window 600, which is shown in FIG. 6. The main menu window 600 illustratively includes a plurality of options including, for example, options to transfer a current account 605, bank securities 610, a mortgage 615, insurance 620 or the entire package 625. It should be noted that in alternative embodiments, additional and/or different options may be provided in the main menu window 600. As such, the description of fields 605-625 should be taken as exemplary only.

From the main menu window 600, a user then selects the current account option 605 in step 420. Illustratively, the current account option 605 enables a user to transfer a current account from one financial institution to other. Examples of current accounts include, for example, checking accounts, negotiable order of withdrawal (NOW) accounts, savings accounts, money market accounts, etc. In response to the user selecting the current account option 605, the transfer application 230 displays an exemplary GUI window 700 (shown in FIG. 7) in accordance with an illustrative embodiment of the present invention. The window 700 exemplary includes an identifier field 705, a current bank account field 710 and an account information field 715. The identifier field 705 identifies that the transfer application 230 is displaying the current account option. The current financial institution field 710 identifies the current financial institution. Illustratively, the field 710 lists the name of the financial institution and, in alternative embodiments, may display a logo of the financial institution. The account information field 715 illustratively displays a current capital balance and a current interest rate associated with the current financial institution. In alternative embodiments, additional and/or differing information may be displayed regarding the current financial institution.

Also displayed within window 700 is a forward arrow button 720 and backward arrow button 725 as well as logos 730 of financial institutions to which the current account may be transferred. The user may utilize arrow buttons 720, 725 to scroll through a list of financial institutions in step 425. Illustratively, the financial institution's logo will appear in the space between arrows. For example, in FIG. 8, a new logo 805 is displayed in exemplary window 800.

In step 430, a user selects a financial institution as a destination to transfer his current account. This may be accomplished by, for example, the user clicking the logo 805 of the financial institution in window 800. In response to the user clicking on the logo 805, the transfer application 230 displays an exemplary GUI window 900 as shown in FIG. 9. Window 900 includes an indicator 905 of the financial institution to which the current account is to be transferred as well as a confirmation button 910. When the user selects the confirmation button 910, the user signifies to the transfer application 230 that the user has selected the financial institution associated with the indicator 905.

The transfer server forwards a command to transfer the funds in the current account from the old financial institution in step 440. The old financial institution then, in step 445, transfers the funds to the new financial institution and closes the account. The funds may be transferred by, for example, a wire transfer, the automated clearing house (ACH) system, etc.

The transfer server then displays a confirmation to the user in step 450. FIG. 10 is an exemplary GUI window 1000 illustrating an exemplary confirmation in accordance with an illustrative embodiment of the present invention. The window 1000 includes a current financial institution field 710 identifying the new financial institution as the current financial institution. Field 715 displays information relating to the current financial institution. A confirmation field 1005 displays a confirmation message as well as information relating to changed between the old and new financial institution. The procedure then completes in step 450.

FIG. 11 is a flowchart detailing the steps of a procedure 1100 for transferring a securities account in accordance with an illustrative embodiment of the present invention. The procedure 1100 begins in step 1105 and continues to step 410 where the user accesses the transfer application. The user the logs into the transfer application in step 415. Steps 410-415 are described above in window 400 (FIG. 4). From the main menu window 600, the user selects the securities option 610 in step 1110. In response to selecting the securities option 610, the transfer application 230 displays an exemplary graphical user interface window 1200 (FIG. 12). Window 1200 illustratively comprises of an indicator 1205 that the window is displaying information relating to the securities transfer option. The window 1200 also comprises an indicator 1210 of the current financial institution as well as a field 1215 displaying information relating to the current financial institution. Illustratively, field 1215 comprises information relating to the total capital in the securities account as well as information relating to the income generated by the securities. An exemplary button 1220 enables the user to see information relating to the securities within the account. In response to selecting button 1220, the transfer application 230 displays exemplary window 1300 (FIG. 13), described further below. Also displayed within window 1200 is a forward arrow button 720 and backward arrow button 725 as well as logos 730 of financial institutions to which the securities account may be transferred. The user may utilize arrow buttons 720, 725 to scroll through a list of financial institutions in step 1115. Illustratively, the financial institution's logo will appear in the space between arrows. For example, in FIG. 14, a new logo 805 is displayed in exemplary window 1400.

FIG. 13 is an exemplary GUI window 1300 illustrating details about the securities within the securities account in accordance with an illustrative embodiment of the present invention. Window 1300 illustratively comprises a listing of the securities within the securities account. Window 1300 may also comprise a graph showing the historical share price of securities within the account. It should be noted that in alternative embodiments, additional and/or differing types of data may be shown in window 1300. As such, the description of a listing of securities as well as a graph of share prices should be taken as exemplary only. Window 1300 also illustratively comprises a back button 1310 that, when clicked, returns the user to window 1200.

The user then selects a financial institution in step 1120. Selecting the financial institution may occur by, for example, clicking on the logo 805 of the new financial institution. FIG. 15 is an exemplary GUI window 1500 illustrating the selection of a financial institution in accordance with an illustrative embodiment of the present invention. Window 1500 comprises an field 1505 that indicates the selected financial institution and a button 1510 to execute the transaction. The window 1500 also includes a field 1515 that displays information related to the new financial institution including, e.g., changes to interest rates and/or changes in net interest.

In response to the user selecting the financial institution, the transfer server forwards a command to transfer securities from the old financial institution in step 1130. The old financial institution transfers the securities and closes the account in step 1135. The transfer application then displays a confirmation to the user in step 1140. FIG. 16 is an exemplary GUI window 1600 displaying a confirmation in accordance with an illustrative embodiment of the present invention. Window 1600 illustratively includes a field 1210 identifying the new current financial institution, i.e., the financial institution to which the securities account has just been transferred. An account information field 1605 identifies information relating to the new account including, e.g., the capital amount, interest rate and estimated annual interest earned. A confirmation field 1610 indicates that the transfer was successful as well as information related to the better terms that have been obtained by the transfer. The procedure 1100 then completes in step 1145.

FIG. 17 is a flowchart detailing the steps of a procedure 1700 for transferring a mortgage account in accordance with an illustrative embodiment of the present invention. The procedure 1705 begin in step 1705 and then continues to step 410 where the user accesses the transfer application. Once the application has been accessed, the user then logs into the transfer application in step 415. Steps 410-415 are described above in relation to window 400 (FIG. 4). From the main menu window 600, the user selects the mortgage option in step 1710. As a result of selecting the mortgage option, the transfer application 230 displays an exemplary window 1800. Window 1800 includes the field 1305 identifying that user is within the mortgage option. Window 1800 also includes a indicator work 1810 indicating the current bank with which the mortgage is associated. Further, window includes a field 1815 indicates information regarding the current mortgage, such as, the capital amount, the monthly interest rate and the monthly payment. It should be noted that in alternative embodiments, additional and/or different information relating to the current mortgage may be displayed in field 1815. Window 1800 also includes a forward 720 and backwards 725 field as well as a icon some very indicative of other banks that may be chosen.

The user then scrolls through the various options in step 1715. FIG. 19 is an exemplary GUI window 1900 in accordance with an illustrative embodiment of the present invention. Exemplary window 1900 illustrates that a different bank icon 805 has been scrolled by using, e.g., the forward 720 and backwards 725 buttons. A user may select the icon 805 if the user desires to transfer the mortgage account to the bank associated with icon 805. In step 1720, the user then selects a financial institution. FIG. 20 is an exemplary GUI window 2000 in accordance with an illustrative embodiment of the present invention. Illustrative window 2000 includes a field 2005 showing indicate work of a bank to which the market account is to be transferred. Window 2000 also illustratively includes a move to button 2010 that may be selected to indicate the user's desire to initiate a transfer. Windows 2000 also illustratively includes the field in 2015 that displays information relating to a potential transfer. Such information may include, for example, a change in the interest rate, change in a monthly payment, etc. It should be noted that in accordance with alternative embodiments the present invention, additional and/or different information may be displayed in field 2015. The transfer server communicates with the new financial server to verify mortgage compatibility in step 1725. FIG. 21 is an exemplary GUI window 2100 in accordance with an illustrative embodiment of the present invention. Windows 2100 comprises a status field 2105 that comprises a plurality of sub fields. Field 2110 identifies the current bank, while a future bank field 2115 identifies the bank or other financial institution to which the mortgage is to be transferred. A series of individual step status indicator towards 2120, 2125, 2130, will be eliminated and/or change as the final steps of the procedure 1700 are performed. A virtual notary then authenticates the user's signature in step 1730. FIG. 22 is an exemplary GUI window 2200 in accordance with an illustrative embodiment of the present invention. Window 2200 includes an indicator 2205 that the mortgage has been verified in accordance with an illustrative embodiment of the present invention.

The system then finalizes the execution of the mortgage in step 1735. FIG. 23 is an exemplary GUI window 2300 in accordance with an illustrative embodiment of the present invention. The transfer server then displays a confirmation in step 1740. FIG. 24 is an exemplary GUI window 2400 illustrating a confirmation in accordance with an illustrative embodiment of the present invention. Window 2400 illustratively includes a field 2405 indicating the current financial institution holding the mortgage account, a field 2410 displaying account information and a field 2415 displaying confirmation information. The procedure 1700 then completes in step 1745.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on one or more tangible (non-transitory) computer-readable storage media (e.g., disks/CDs/etc.) having program instructions executing on a computer, hardware, firmware, or a combination thereof. It should be noted that while various GUI components have been described in relation to the various GUI windows, in alternative embodiments, additional and/or different GUI components may be utilized. Also, the layouts of the various windows may differ in alternative embodiments. As such, the description of the layout and components of the various GUI windows should be taken as exemplary only. Accordingly this description is to be taken only by way of example and not to otherwise limit the scope of the embodiments herein. Therefore, it is the object of the appended claims to cover all such variations and

What is claimed is:

1. A method for transferring an account from a first financial institution to a second financial institution, the method comprising:
login into, by a user, a transfer application executing on a transfer server;
selecting the second financial institution from a set of financial institutions;
transmitting, by the transfer server, a
transferring, by the first financial institution, the account from the first financial institution to the second financial institution; and
displaying a confirmation window.

2. The method of claim 1 wherein selecting the second financial institution comprises selecting an icon associated with the second financial institution in a graphical user interface provided by the transfer server.

3. The method of claim 1 wherein the account comprises a current account.

4. The method of claim 3 wherein the current account comprises a checking account.

5. The method of claim 1 wherein the account comprises a securities account.

6. The method of claim 1 where the confirmation window comprises an identifier of differences in terms between the first financial institution and the second financial institution.

7. The method of claim 6 wherein the terms comprises an interest rate.
